(19) United States
(12) Patent Application Publication
(10) Pub. No.: US 2002/0109591 A1
(43) Pub. Date: Aug. 15, 2002

(54) Pressure sensitive edges

(76) Inventors: Peter Tracey, Bury St Edmunds (GB); Colin A. Botting, Bury St Edmunds (GB)

Correspondence Address: Finnegan, Henderson, Farabow,, Garrett & Dunner, L.L.P., 1300 I Street, N.W., Washington, DC, 20005-3315, US

(21) Appl. No.: 09/790,670

(22) Filed: Feb. 23, 2001

(30) Foreign Application Priority Data
Feb. 28, 2000 (GB) 004693.8

(51) Int. Cl. G08B 21/00

(52) U.S. Cl. 340/540; 340/545.1

(57) ABSTRACT

There is disclosed a sensing means for controlling the movement of a component which is provided with a sensor which outputs an output signal which varies upon deflection of the sensor, a control means which comprises a memory for storing a threshold value, a means for comparing the sensor output with the threshold value and an output means to provide a control output signal on the basis of said comparison. The sensing means is also provided with a threshold setting means which samples the sensing output at a predetermined state of the system and also stores the sampled value as a threshold value for future operations.

The present invention relates to sensing edges. In particular, pressure sensitive edges for use in, for example, automatic doors.

Pressure sensitive edges are used in a wide range of applications. These applications include many types of power operated door, including those on mass transit vehicles, lifts and the interior and exterior doors and shutters of buildings. Pressure sensitive edges are also used as machinery guards (e.g. in the form of pressure bumpers) to protect machine operators from moving parts of the machinery.

Pressure sensitive edges may be fitted to a moving part where a trapping, crushing or collision hazard may occur. They may also be fitted to a fixed part to prevent trapping or crushing hazards with a moving part. The sensor may additionally be embodied as a bumper to detect collision between a vehicle and an obstacle.

A pressure sensitive edge comprises a sensor and a control unit. The sensor provides an output signal which changes when pressure is applied to the sensor to cause deflection or deformation of the sensor, and the control unit responds to the change in output signal from the sensor and generates a control signal to control the relevant equipment. The control signal may be interfaced with the control system of the power operated equipment so that force/pressure applied to the sensor of the pressure sensitive edge results in the equipment reverting to a safe condition. The safe condition may involve stopping or reversal of the power operated equipment. The control signal may additionally or alternatively operate an alarm.

Many current designs of sensing edges use electrical contacts in the sensor which are normally held open, and close when the sensor is pressed. Other designs detect a change in the resistance of a resilient carbon loaded foam (or similar composite material) which is compressed when the sensor of the pressure sensitive edge is pressed.

Such designs, however, generally provide no means by which the sensitivity of the sensor to applied pressure can be adjusted or regulated. This is because the deflection of the sensor required to change its output signal, and the force required to cause that deflection, are features of the physical design of the sensor and of the properties of the materials used.

It is known to use an optical fiber sensor in a control system, for example a control system for an industrial machine, an automatic door, or an electrically powered vehicle window. The optical fiber is placed and arranged so that it is deformed when an abnormal condition arises, such as a machine operator treading on a pressure mat incorporating the fiber placed in an exclusion zone around the machine, or a person's body being hit by an edge of an automatic door incorporating the fiber or being trapped between the edge of a vehicle window and the window frame.

A series of optical pulses can be transmitted along the fiber from a source such as a light emitting diode to a sensor such as a photodiode, and the amplitude of the output of the sensor is processed and monitored. When an abnormal condition arises, the transmittance of the fiber is reduced. This reduction in transmittance is detected by the photodiode and the control system responds by rendering safe the apparatus which it controls, for example by switching off the machine, or stopping the movement of the door or window, or by reversing the motion of the door or window. In the known arrangement the optical and electrical system can be designed to be “fail-to-safe”, that is to say any fault which arises in the system should result in the apparatus which it controls being placed in the safe state.

The applicant's prior patent application GB

2236388 discloses a system which incorporates such an optical fiber arrangement and further processing circuitry to prevent inadvertent activation of the safety system in the event of interference or “spikes” from external electrical equipment.

Further designs of pressure sensitive edges use the principle of transmitting a beam of light between a light source and a photo-electric detector which monitors the amount of light received. The light source and the detector are mounted in a tube which is part of the sensor of the pressure sensitive edge, normally at opposite ends. When the tube is distorted, the received light level changes. The control unit responds to the change in signal from the photo electric detector and varies its control signal accordingly (for example to reverse the motion of a door).

A first disadvantage of the designs of the prior art is that the sensitivity or level of response to actuating pressure is pre-set either during manufacture or during installation. This pre-set sensitivity may be determined by the design of the sensor of the pressure sensitive edge, as in a system with electric contacts. Following manufacture, there is no possibility of changing the sensitivity during installation. If the installation is poorly carried out, for example by attaching the sensor to an uneven surface so that it is deformed, the sensitivity may vary from the designed level.

It is also known to use air pulse switches to detect an air pressure pulse generated by squeezing a sealed tube formed in the sensor of the pressure sensitive edge.

In this case, sensitivity is a function of the sensor components, by means of which the air pulse system is set to actuate at a certain air pressure. If this air pulse switch is adjusted during installation, it is subject to the ability of the installer and can also be reset later to unacceptable levels.

U.S. Pat. No.

5,426,293 concerns a system which includes a light transmitter and receiver within the sensor. The light transmitter and receiver are provided at opposite ends of the sensor and a means is provided within the sensor cavity for setting the sensitivity of the sensor. In other words, the sensitivity is preset by adjusting the amount of light which normally falls on the light detector when the sensor is undeformed. The sensitivity of the system must be pre-set on the sensor during installation or servicing. This depends on the ability of the installer and is subject to many variables such as mechanical damage which may realign the components so that they reduce the level of sensitivity and, as a result, safety.

Whenever sensitivity is pre-set, allowance must be made for a wide variety of ambient conditions. As a result either sensitivity is less in the worst conditions, or if sensitivity is adequate in worst conduction, the system may be oversensitive in normal conditions.

A second disadvantage of existing designs occurs when the sensor on a door has been closed for a long time, perhaps permanently compressing the sensor to exclude drafts. The sensor may not operate with the same level of sensitivity when the door is eventually operated.

An objective of the present invention is to provide a sensing edge whose sensitivity setting is independent of the level of skill of the operative installing the sensing edge.

A further objective of the present invention is to provide a sensing edge whose sensitivity can be set and reset after installation without disturbing any of the mechanical elements of the sensing edge.

A further objective of the present invention is to provide a sensing edge which is self-calibrating, and whose overall sensitivity is automatically maintained despite changes in ambient conditions.

A yet further objective of the present invention is to provide a sensing edge whose sensitivity can be controlled so as to be variable during a cycle of operation of the equipment on which the sensing edge is operating.

The pressure sensitive edge of the present invention seeks to achieve these objectives by providing a system having a level of sensitivity to pressure which is dependent on the associated electronic control system and not on the mechanical configuration of the sensor or the skill of the installation engineer. The control system may automatically adjust for changes in the way the systems is installed. Poor installation ceases to be a problem and pre-established safety levels are ensured.

The present invention achieves the second objective by providing processing means and storage means which update and store the sensitivity value of the sensor during the operational life of the sensor.

The present invention achieves the third objective by providing measuring means to measure various parameters in the ambient conditions, so as to adjust the sensitivity value of the sensor during operation.

The present invention achieves the fourth objective by providing means which allows the sensor to adjust its sensitivity during an operation cycle. In one particular application example, it is desirable that a relatively high force on the sensor is required in the initial closing stages of a bus door to disengage the power operated drive. However, when the door is almost closed, this same sensitivity adjustment is then insufficient to detect a small object such as a neck tie or the strap of a handbag.

According to one aspect of the present invention, there is provided a sensing means operable to control the movement of a component, comprising; a sensor providing an output signal which varies with an amount of deflection of said sensor; a control means which comprises a memory for storing a threshold value, a means for comparing said sensor output with said threshold value and an output means to provide a control output signal on the basis of said comparison; wherein said sensing means further comprises a threshold setting means arranged to sample the sensor output at a predetermined state of the system and is further operable to store a threshold value based on said sampled value.

According to a second aspect of the present invention, there is provided a sensing means as described above, wherein said threshold setting means is arranged to sample said sensor output every time said sensing means is activated and store a corresponding threshold value.

According to a third aspect of the present invention, there is provided a sensing means as described above, further comprising a position detecting means for detecting a position of a moveable component and wherein said threshold setting means is arranged to sample said sensor output at predetermined positions in the range of movement of the component, and is further operable to store threshold values based on said sampled values.

According to a fourth aspect of the present invention, there is provided a sensing means as described above which further comprises sensing means for sensing an ambient parameter such as temperature or humidity and wherein said threshold setting means is arranged to set an operating threshold on the basis of said sampled sensor output and said sensed ambient parameter.

Exemplary embodiments of the present invention will now be described with reference to the accompany drawings in which:

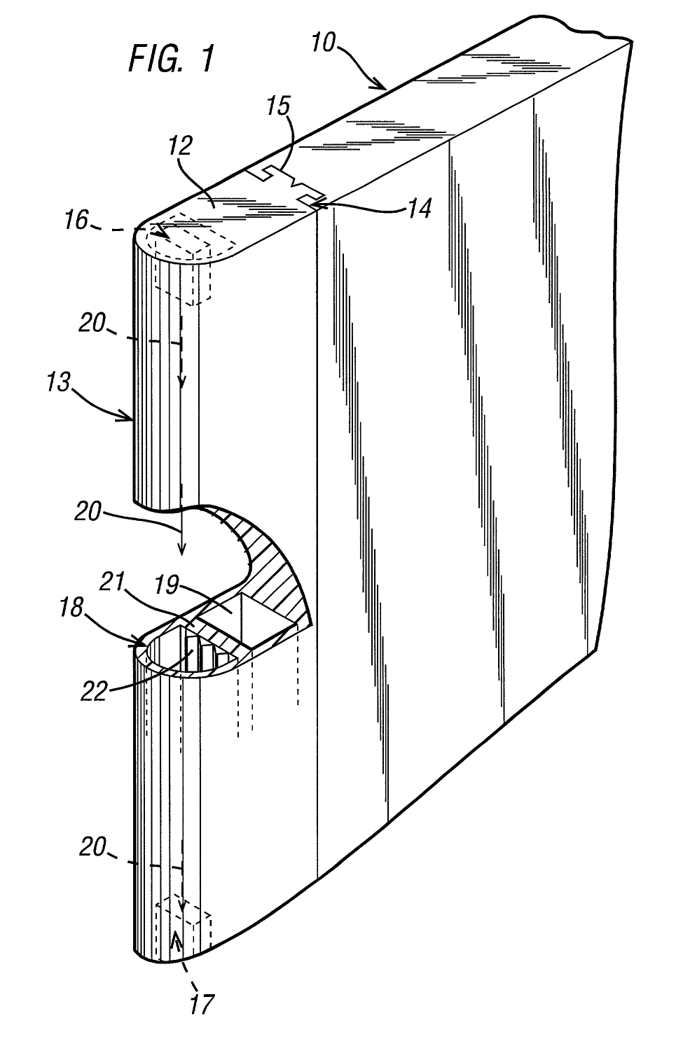

FIG. 1 is a perspective diagram showing a section of a door provided with a pressure sensitive edge;

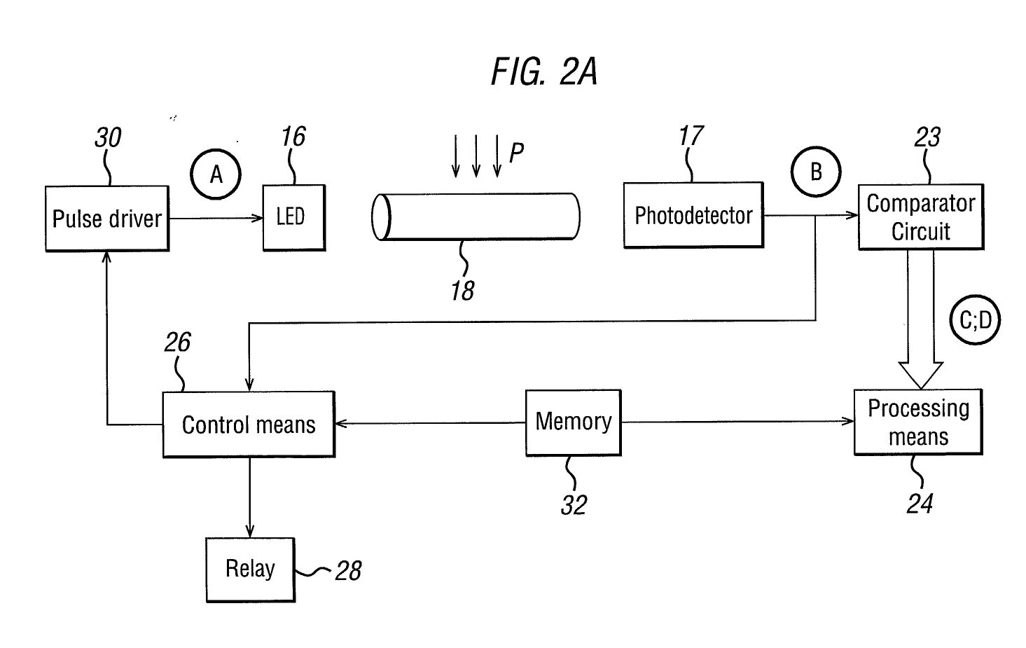

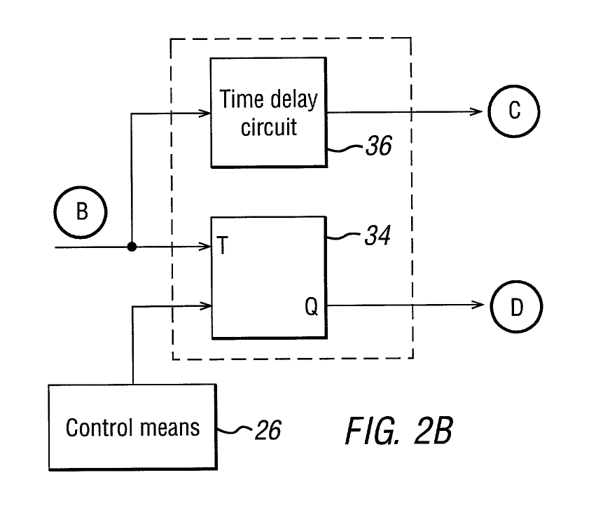

FIG. 2a is a schematic block diagram of a pressure sensitive edge system in a preferred embodiment;

FIG. 2b is a circuit diagram of a comparator circuit and also schematically illustrates a control means in block form;

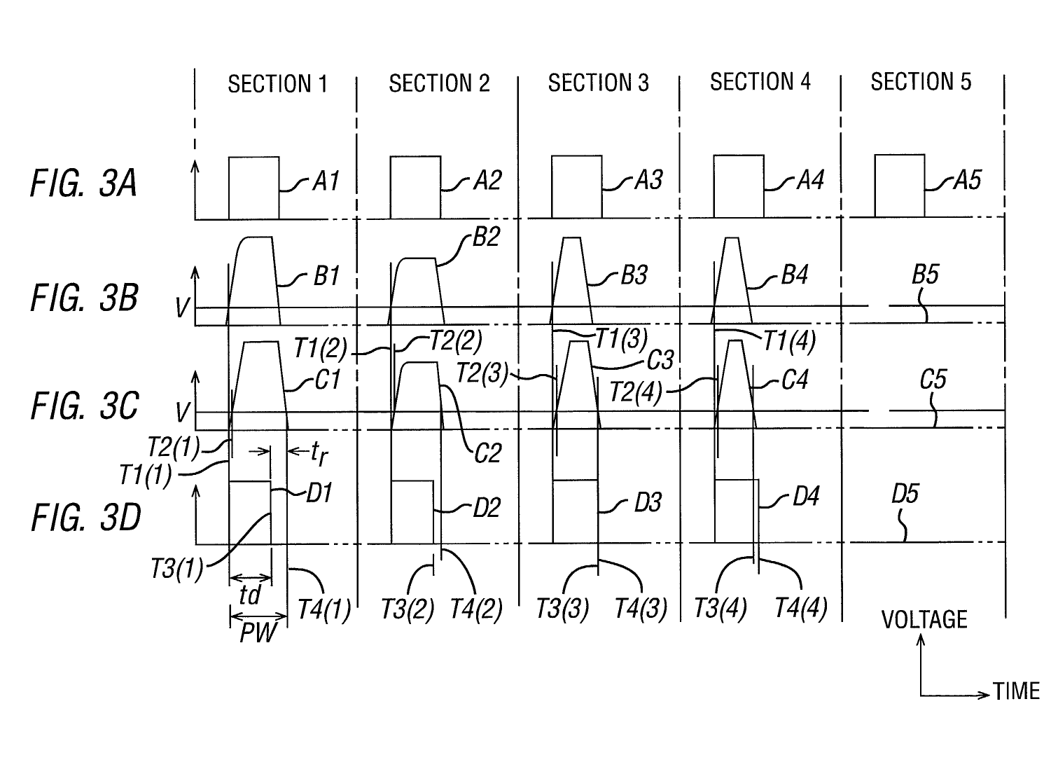

FIG. 3 illustrates signal waveforms arising at various points in the system;

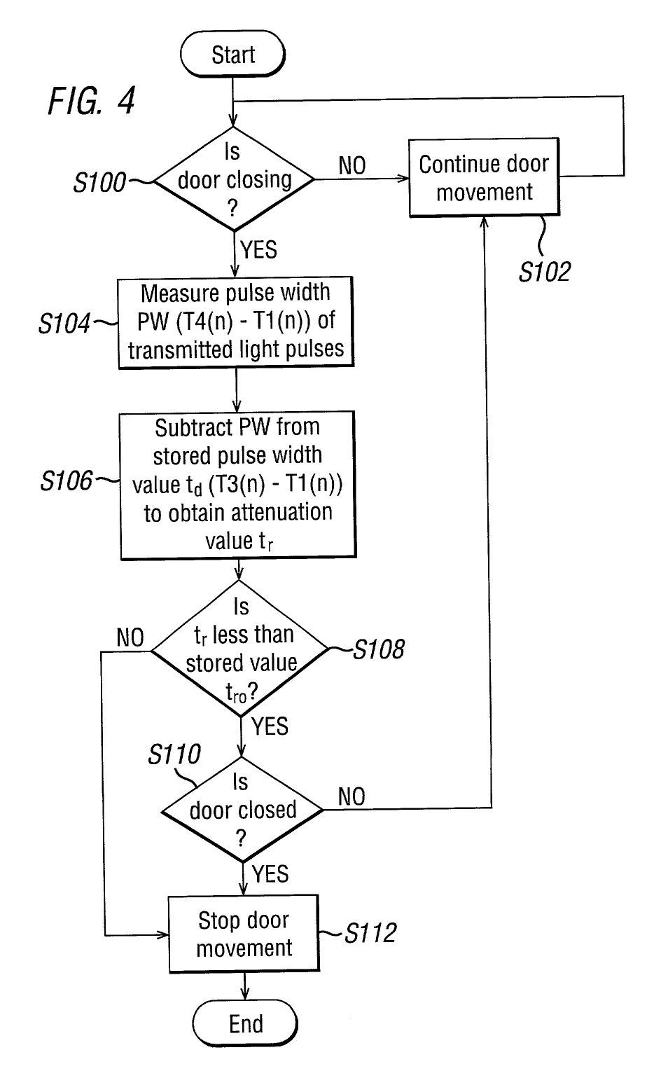

FIG. 4 is a flow diagram illustrating the steps in door operation in a preferred embodiment;

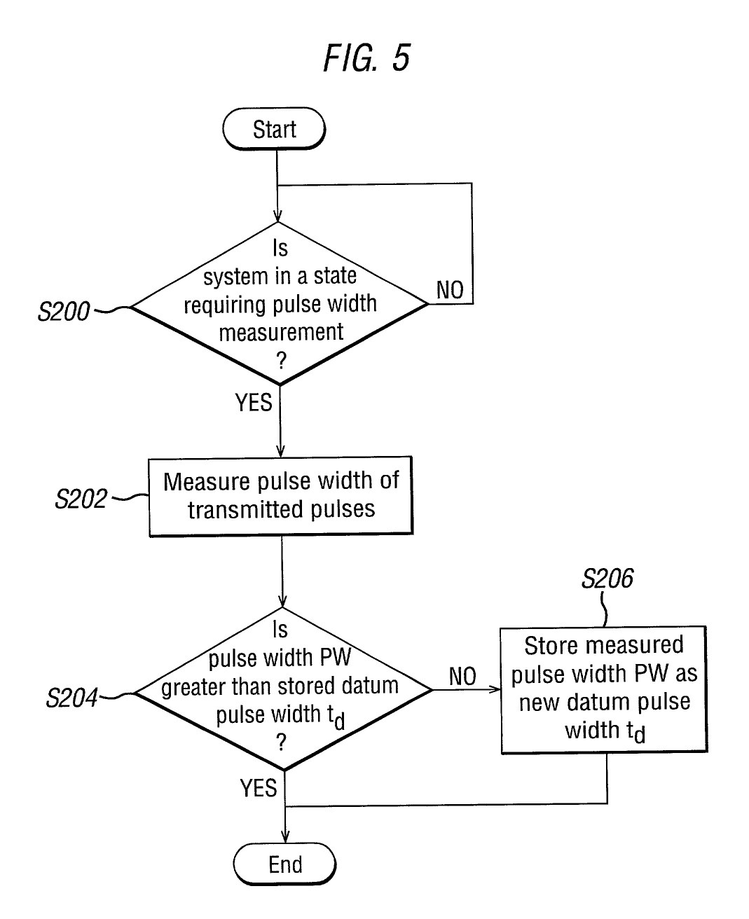

FIG. 5 is a flow diagram illustrating a “self-calibration” process which allows the pressure sensitive edge to adjust its sensitivity according to ambient conditions;

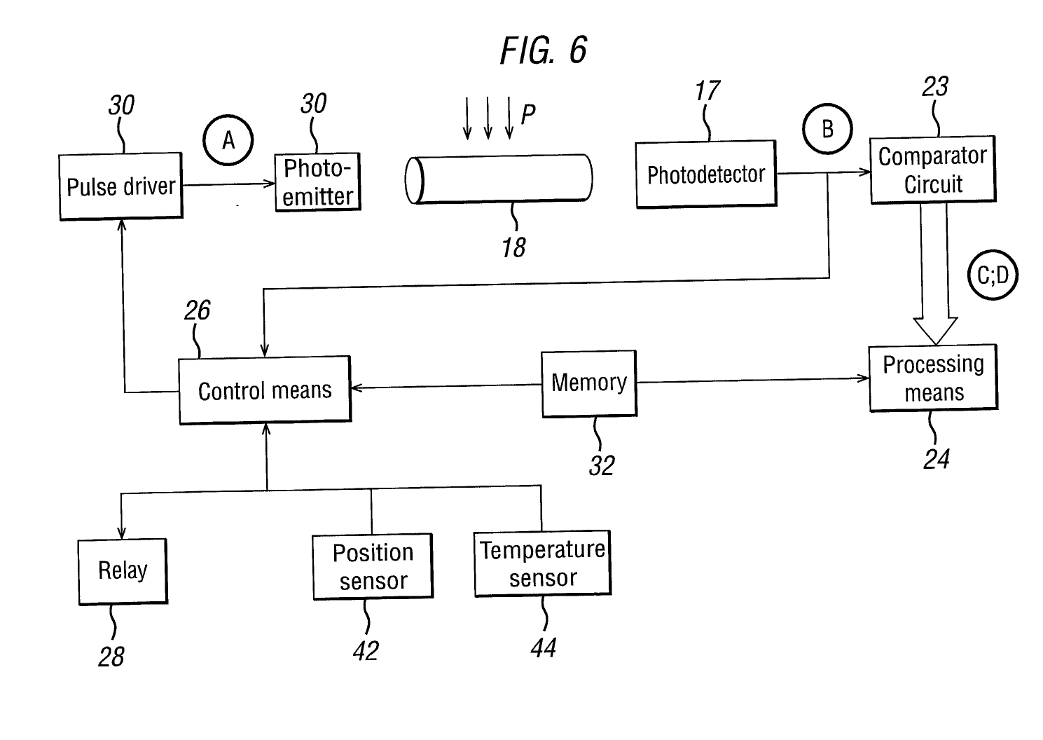

FIG. 6 is a schematic block diagram of a pressure sensitive edge system in another embodiment;

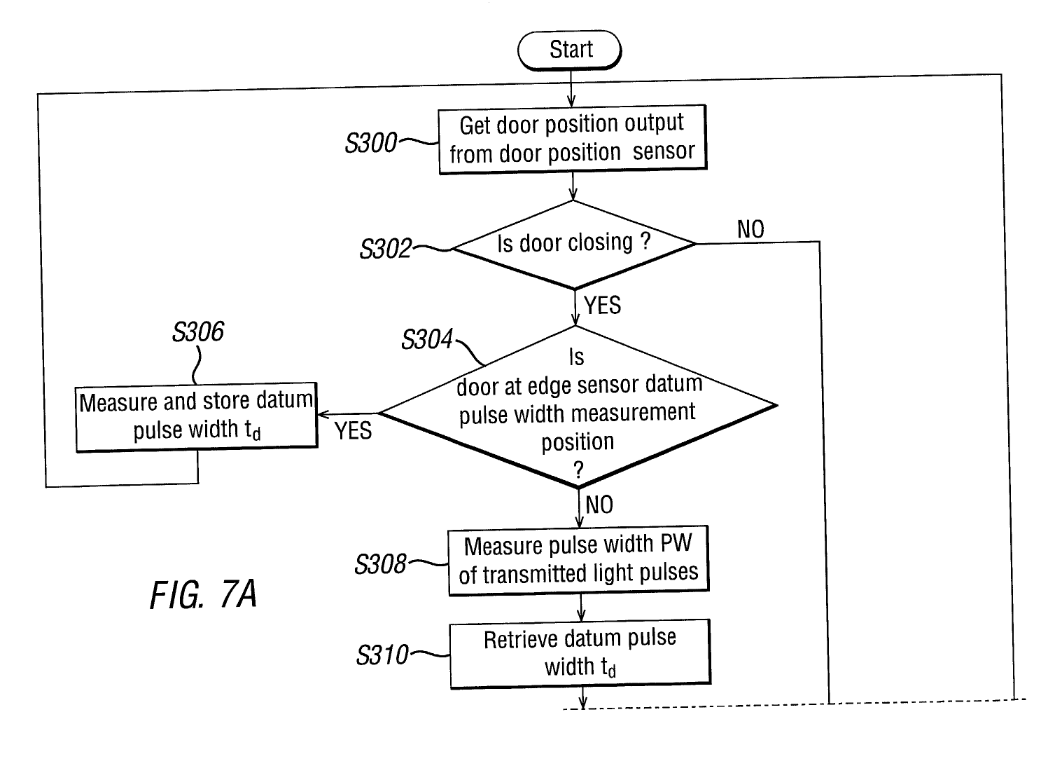

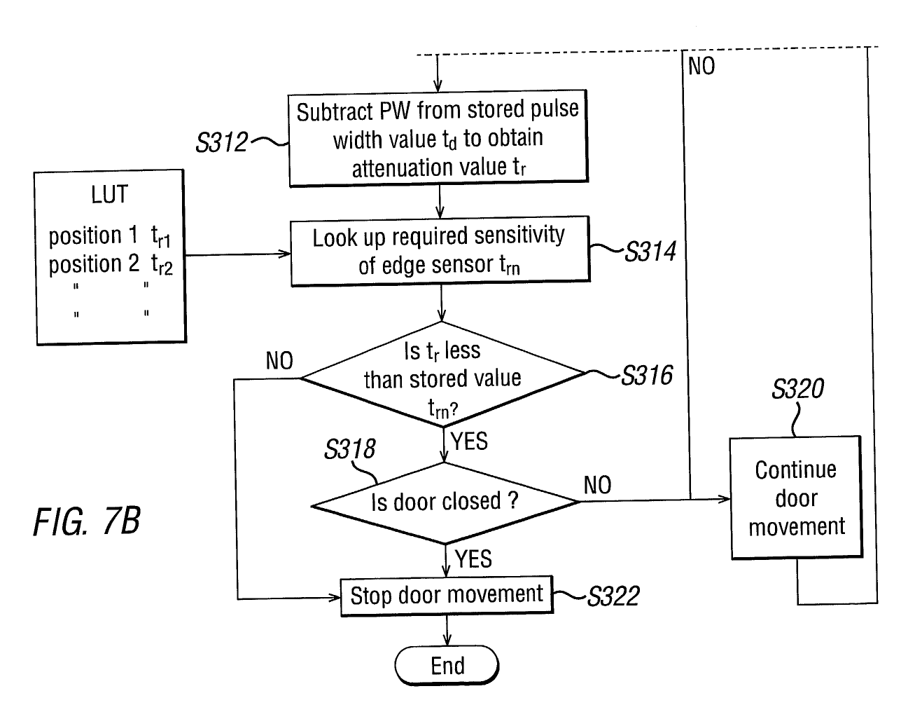

FIG. 7 is a flow diagram which illustrates the operation of the pressure sensitive edge system in the apparatus shown in FIG. 6;

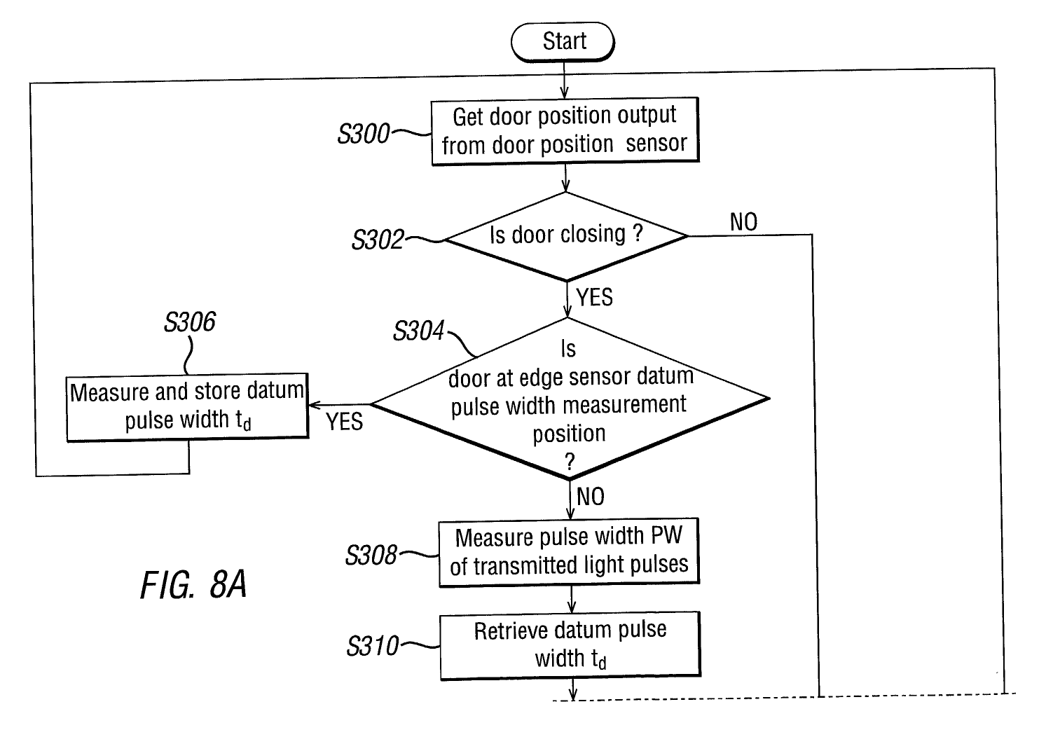

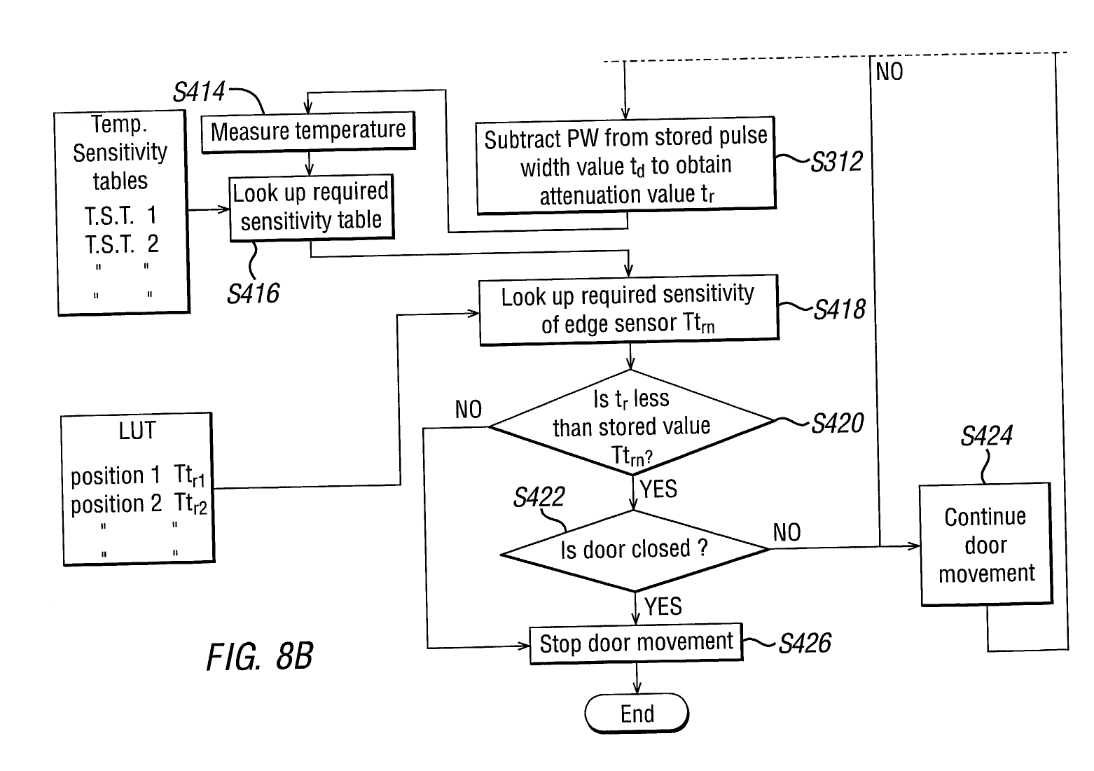

FIG. 8 is a flow diagram which illustrates the operation of the apparatus in FIG. 6 in a different embodiment to that of FIG. 7; and

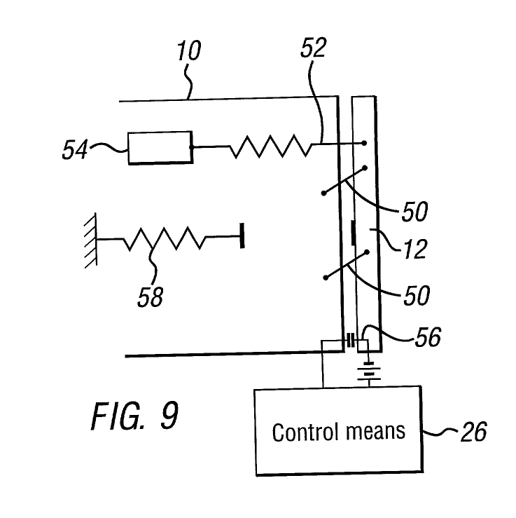

FIG. 9 is a schematic diagram which illustrates a mechanical equivalent in an alternative embodiment.

FIG. 1 schematically illustrates a power operated sliding door 10 which is provided along its contacting edge with a sensing edge 12 which is constructed from resiliently deformable material which in a preferred embodiment is an elastomeric material. The sensing edge 12 defines a leading edge or edge portion 13 and a base portion 14. The base 14 and edge 13 portions define two internal hollow tubes 18,19 separated by a bulkhead 21 which is parallel to the base 14 of the sensing edge. The tube 18, which is the outermost of the two tubes (i.e. the furthest from the base portion 14) acts as a light tube and is provided with a photo-emitter 16 at one end and a photo detector 17 at the other end. When pressure is exerted on the tube 18 in the direction of the base 14, the tube 18 is deformed so as to reduce the cross-sectional area of the lumen of the tube 18, reducing progressively its ability to transmit light from the emitter 16 to the detector 17. The light tube 18 prevents light from leaving the sensing edge. An advantage of enclosing the light source and sensor in such a way is that the ingress of dust or other environmental contamination, or ambient light is avoided.

The bulkhead 21 is also provided with a plurality of ribs which extend longitudinally within the light tube 18 along the length of the sensor. These ribs 22 are provided to prevent the lumen of the tube 18 from becoming fully occluded when a pressure is exerted against the leading edge 13 of the sensing edge 12. Such a situation is undesirable because it may cause the sensing system to fail.

In order that the sensing edge 12 may be mounted to the door 10, a coupling portion 15 is provided on and extends from the base 14. The coupling portion is a “T” section rib, undercut to allow it to be inserted into a corresponding recess formed at the edge of the door 10, either in the door itself or in a mounting strip attached to the door edge.

The general arrangement of the pressure sensitive edge system is shown in FIG. 2a. The system comprises a light source 16, driven by a driving circuit 30. Light from the light source 16 passes through a light guide (the light tube 18) and is detected by photo detector 17. The output of the photo detector 17 is fed to a filter circuit 23. A control means 26 controls the operation of filter circuit 23 and of the driving circuit 30 providing the driving signals to the light source. The filter circuit 23 provides output signals to a processing means 24 linked to a memory 32. Control means 26 also has access to the memory 32. To provide a control output to the equipment associated with the pressure sensitive edge system, the control means 26 controls a relay 28 linked to the equipment.

Referring to FIG. 2a, a pulse driver 30 produces a rectangular wave electrical signal A comprising pulses having a pulse width of about 35 microseconds spaced by intervals of from about 40 microseconds to several seconds. The preferred spacing is about 7 milliseconds. The signal A which is supplied to a photo emitter 16, such as a light emitting diode. The resulting optical signal is supplied to one end of the light tube 18 which can be caused to deform when an external pressure P is applied. Thus, substantially all of the optical signal is transmitted to the other end of the light tube 18 when external pressure is small and the tube is undeformed, but the optical signal is substantially attenuated when pressure P is large. This optical signal is supplied to a photo detector 17 such as a photo diode or photo transistor, and a resulting amplified electrical signal B is fed to a comparator circuit 23, described in detail below in relation to FIG. 2b. Signals C and D are fed to a processing means 24, where these signals are operated on by the processing means and a reference time tᵣ obtained from these signals C and D is then stored in a memory 32 which then forms the predetermined pulse signal with which reference time tᵣ is compared in the processing means 24 in future operations of the device. The operation of control means 26 and a relay 28 in this circuit will be described later after the description relating to FIG. 2b.

The comparator circuit 23 is shown in more detail in FIG. 2b. The input signal B is applied to the trigger input T of a TTL timer 34, and is also applied via a time delay circuit 36 as a signal C to the processing means 24. An output signal from the timer 34 changes state for a reference time period when the input signal B rises above a threshold. The time delay circuit 36 acts to delay the passage of signal C to the processing means 24 to overcome the effect of propagation times within the logic devices.

The response of the system will now be described with reference to FIG. 3, which is divided into five sections to illustrate the outputs of the sensor system components in different operating conditions, as follows:

1. Section 1 shows the response to a normal pulse when no pressure P is applied;

2. Section 2 shows the response to a normal pulse when no pressure P is applied and when the output of the photodetector 17 is reduced due to ambient conditions;

3. Section 3 shows the response to a normal pulse when a small pressure P is applied;

4. Section 4 shows the response to a normal pulse when a larger pressure P is applied; and

5. Section 5 shows the response to a normal pulse when a very large pressure P is applied.

Referring to Section 1 of FIG. 3, the optical pulse produced by a source electrical pulse A1 is transmitted through the light tube 18 and produces at the detector a corresponding electrical pulse B1, with slightly more ramped rising and falling edges, exaggerated in FIG. 3 for the purpose of clarity. The pulse B1 rises through a threshold voltage V of the timer 34 at time T1(1) and causes a pulse D1 to commence at that time. The pulse B1 is also delayed by the time delay circuit 36 to produce a pulse C1 which rises through a threshold voltage V of the processing means 24 at a slightly later time T2(1). Subtracting pulse width value PW (i.e. T4(1)−T1(1)) from stored pulse width value t_{d} (i.e. T3(1)−T1(1)) to obtain reference time tᵣ results in a positive value for tᵣ. On initial power up of the above system, after reference time tᵣ has been obtained, it is stored in the memory 32 as a reference value tᵣₒ for comparison with subsequent reference times tᵣ.

If the voltage from the detector should decrease, as shown by pulses B2, C2 in section 2 of FIG. 3, it will be appreciated that this has a very small effect on the timings T1 and T2 but otherwise the system reacts in a similar fashion to that shown in section 1 of FIG. 3.

Referring to section 3 of FIG. 3, the optical pulse produced by a source electrical pulse A3 is transmitted through a partially occluded light tube due to the pressure P exerted upon the light tube. As a result, the corresponding electrical pulse B3 produced at the detector is slightly attenuated compared to the cases where no pressure is exerted on the light tube. The pulse B3 rises through the threshold voltage V of the timer 34 at time T1(3) and causes pulse B3 to commence at that time. The pulse B3 is also delayed by the time delay circuit 36 to produce a pulse C3 which rises through the threshold voltage V of the processing means 24 at a slightly later time T2(3). However, in this case, unlike the first two cases, due to the attenuation of pulse B3 and the corresponding attenuation to pulse C3, pulse C3 falls below threshold voltage V before pulse D3 falls below the threshold voltage of the timer 34. As a result reference timer tᵣ equals zero ((T4(3)−T1(3))−(T3(3)−T1(3))=0).

Referring to section 4 of FIG. 3, the optical pulse produced by a source electrical pulse A4 is transmitted through the light tube 18 on which a large pressure P is exerted. As a result, the corresponding electrical pulse B4 is largely attenuated but still rises through the threshold voltage of the timer 34 at time T1(4) and causes a pulse D4 to commence at that time. The pulse B4 is also delayed by the time delay circuit 36 to produce a smaller pulse C4, which rises through the threshold voltage V of the processing means at a slightly later time T2(4). Again due to the attenuation of pulse B4 and correspondingly pulse C4, pulse C4 falls below threshold voltage V at time T4(4) but pulse D4 does not fall below the threshold voltage of timer 34 until time T3(4) which occurs at a later time. Thus subtracting pulse width value PW (i.e. T4(4)−T1(4)) from a stored pulse width value t_{d} (i.e. T3(4)−T1(4)) to obtain reference time tᵣ results in a negative value for reference time tᵣ as opposed to the positive values obtained in sections 1 and 2.

Finally, in section 5 of FIG. 3, when a very large external pressure is applied to the light tube 18, the tube becomes almost fully occluded and pulse B5 is not produced. Since pulse B5 is not produced, neither is pulse C5 and so no signal is passed on to the processing means 24.

As described above, the transition between reference time tᵣ being greater than zero and reference time tᵣ being less than zero occurs when the width of the pulse C fails to exceed the threshold value for sufficient time after pulse D has fallen. However, the circuit can be made more sensitive by adjusting the period t_{d} of the pulses D produced by the timer 34 so that they are only slightly shorter than the width of the input pulse. Due to the ramped nature of the leading and trailing edges of the pulses C, the pulse width of the pulses C becomes less, when measured at the threshold voltage, as the pulses are reduced in amplitude. Thus, the pulse width D can be chosen so that the pulse D terminates before a pulse C of large amplitude falls below the threshold voltage V of the processing means 24 (and thus generate an output signal E), but so that the pulse D terminates after a pulse C falls below the threshold voltage V of the processing means 24 of smaller amplitude still in excess of the threshold voltage (and thus not generate an output signal). The period t_{d} of the pulses D is adjusted by the control means 26 which adapts the pulse t_{d} according to information received from the memory 32 via the processing means 24. In this embodiment, when the system is first powered up, it is necessary to ensure that the sensing edge 12 is undeformed as this will give an incorrect value for t_{d}. Then a value for pulse width t_{d} may be obtained and stored in memory 32. The control means 26 then operates on the timer 34 of the filter circuit 23 so that the pulse width t_{d} is used as a reference value for comparison with the widths of subsequent pulses. In this particular embodiment, the pulse width is set permanently and cannot be further adjusted after initial power up.

FIG. 4 illustrates the operation of the sensing edge 12 after the initial pulse width reference value t_{d} has been obtained at the initial power up. In step S100 the control means 26 determines whether the door is closing or not. If the door is opening then door movement will continue (S102), as it is not necessary to detect for pressure against the sensing edge 12 when the door is opening. If the door is closing then the processing means 24 measures the pulse width PW (T4(n)−T1(n)) of the transmitted light pulses (S104). The processing means 24 then proceeds to subtract the pulse width value PW from the stored pulse width value t_{d} (T3(n)−T1(n)) to obtain an attenuation value tᵣ. The processing means then determines whether the attenuation value tᵣ is less than the value tᵣₒ stored in the memory 32 (S108). If tᵣ is less than the value stored in the memory 32 then this indicates that sufficient pressure is being exerted on the sensing edge 12 and the door movement will stop (S112). If however, tᵣ is greater than the stored valued tᵣₒ, then the processing means 24 determines whether the door is closed (S110) and if the doors are not closed then the process returns to step S100. If however in step S110 the control means determines that the doors are closed then it will proceed to step S112 and door movement will be stopped.

FIG. 5 illustrates the process used in a second embodiment of the present invention. In this embodiment, the pressure sensitive edge is provided with a continuous adaptive self-calibration procedure which allows the sensitivity of the sensing edge to vary according to ambient conditions. The process illustrated in FIG. 5 may be employed at predetermined times within the operation of the pressure sensitive edge, e.g. every time the circuit is switched on, or at various points in the range of movement of the door 10 during closing of the door 10. In this embodiment, the system first determines whether the door is in a state requiring pulse width measurement (S200). If this is not the case then the process returns to the start. However, if the system is in a state requiring pulse width measurements, the processing means 24 measures the pulse width of the transmitted pulses as previously described in relation to FIG. 4 (S202). The processing means 24 then proceeds to determine whether the pulse width PW is greater than the stored datum pulse width t_{d} (S204). If pulse width PW is not greater than the stored datum pulse width t_{d} then the measured pulse width PW is stored as the new datum pulse width t_{d} in the memory 32 (S206). If however, the pulse width is greater than the stored datum pulse width t_{d}, the new datum pulse width is not updated.

Third and fourth embodiments of the present invention will now be described in relation to FIGS. 6, 7 and 8. As can be seen the system comprising the pressure sensitive edge is similar to that described in the first and second embodiments. In a third embodiment, a position sensor senses the position of the door during its range of movement. In this embodiment, the sensitivity of the sensing edge 12 may be varied at various points in the door's range of movement.

FIG. 7 illustrates the process used to carry out the adjustment to the sensitivity of the sensing edge during the door's range of movement.

Initially, the door's position is obtained by the position sensor (S300). The control means then determines whether the door is closing or not (S302). If the door is opening then door movement is allowed to continue (S320). If, however, the door is closing, the control means 26 determines whether the door is at a position where datum pulse width measurement is necessary (S304). If this is the case, the datum pulse width output t_{d} is measured and stored in the memory 32 (S306), and the process returns to the start. When the door is not at a position requiring measurement of the datum pulse width t_{d} then the pulse width PW of the transmitted light pulses is measured by the processing means 24 (S308). The datum pulse width t_{d} is then obtained from the memory 32 (S310) and the pulse width PW is then subtracted from this datum pulse width value t_{d}, to obtain the attenuation value tᵣ (S312). A look up table is stored in the memory 32 and contains values for the attenuation value tᵣ for various positions in the doors range of movement.

The processing means 24 then looks up the required sensitivity of the edge sensor tᵣ for the particular position the door is at (S314). The processing means then compares the measured value of the attenuation value tᵣ with the stored value tᵣₙ (S316), and if the measured value tᵣ is less than the stored value tᵣₙ and the door is closed (S318) then door movement is stopped (S322). However, if the measured attenuation value tᵣ is less than the stored value tᵣₙ then this indicates that for that point in the door's movement, sufficient pressure is being exerted on the sensing edge 12 to indicate that an obstruction to the door movement is present and door movement is stopped (S322).

An advantage of adjusting the sensitivity during the motion of the door in such a way is that during the initial closing stages of the door where there is a low risk of trapping then only a large selection of the sensor edge, caused by a large force exerted on the sensing edge 12 (e.g. a person), will stop door movement. However, when the door is about to close or is closed then there is a risk that a small object (e.g. a person's tie or handbag strap) may be trapped by the door and thus the sensing edge 12 is required to be more sensitive to detect the small deformation caused by such a small item, and control the door or an alarm accordingly.

The fourth embodiment of the present invention will now be described in relation to FIG. 5, 6 and 8. FIG. 8 illustrates a process for measuring and adjusting the sensitivity of the door according to ambient conditions (e.g. different temperatures). Due to the nature of the material which makes up the body of the sensing edge 12, ambient conditions will affect the performance of said sensing edge 12, e.g. in cold conditions a large force may be needed to provide a small deflection in the material which makes up the sensing edge 12. However, in warm conditions then only a slight pressure may be needed to produce the same deflection in the material of the sensing edge 12.

The initial steps in the above process are the same as those previously described in FIG. 7 and like reference numerals are used in this figure. When the attenuation value tᵣ has been obtained (S312) the temperature sensor 44 measures the temperature of the material in the body of the sensing edge 12 (S414). The memory 32 stores a list of temperature sensitivity tables which contain required sensitivity of the edge sensor values Tₜᵣ for varying positions in the door's range of movement. The processing means 24 looks up the required sensitivity table depending on the measured temperature (S416). The processing means 24 then proceeds to look up the required sensitivity of the edge sensor for the position of the door in the present conditions (S418). The processing means 24 then compares the measured attenuation value tr with the stored value Ttᵣₙ and if the measured value tᵣ is less than the stored value Ttᵣₙ and the door is closed then door movement is stopped (S420, S422, S426). If however, the measured attenuation tᵣ is less than the stored value Ttᵣₙ then this indicates that sufficient pressure is being exerted on the sensing edge 12 for the present conditions and door movement is stopped (step S426).

The light emitted by the LED or light source 16 may be visible light, or may be infra-red or UV light. In an alternative embodiment, the emitter 16 and deflector 17 are respectively a loudspeaker and microphone, and sound waves are used instead of light to transmit pulsed signals along the tube 18. Ultrasound frequency may be used to avoid interference from audio sources.

### Alternative

In the embodiment described above, deflection of the sensing edge was detected by the attenuation of the light pulses received at the photo diode. As those skilled in the art will appreciate, the objectives of the invention can also be achieved using a mechanical device, as will now be described with reference to FIG. 9. In this Figure, a sensing bar 12 is mounted to a door 10 by a number of pivoting arms 50 which have one of their respective ends fixed to the door 10 and the other fixed to the sensing bar 12. These pivot arms allow the sensing bar 12 to move in directions perpendicular to the adjacent edge of the door 10. A compression spring 52 is provided with one end fixed to the sensing bar and the other to a temperature responsive material 54 which is attached to the door 10. The temperature responsive material 54 may expand or contract according to the ambient temperature conditions, and thus alters the amount of compression in the spring 52 and thus the force needed to deflect the sensing edge 12 according to the ambient conditions. A contact switch 56 is also provided, one part of which is attached to the sensing edge 12, the other being attached to the door 10 so that when sufficient force is applied to the sensing edge 12, the deflection produced in the sensing edge 12 allows the two parts of the switch 56 to contact and operate a control means 26 which then makes the system safe.

Further, the amount of force needed to produce a deflection sufficient to make the system safe can be altered through the motion of the door 10 by providing a compressive spring 58 fixed to a stationary point (e.g. the door frame) which contacts the sensing edge 12 at a certain point in the door's movement when the door 10 is opening, and remains in contact when the door 10 is fully open. When the door 10 closes, the compressive spring 58 remains in contact with the sensing edge 12 until the spring 58 is fully extended and then loses contact with the sensing edge 12. Thus, when the door 10 is nearly closed the amount of force necessary to produce a deflection sufficient to make the system safe is small, because only the force of spring 52 must be overcome. In contrast, when the door 10 is open the amount of force needed to produce a deflection sufficient to make the system safe is large, because the force of both spring 52 and compressive spring 58 must be overcome.

1. A sensing means for detecting the presence of a body in a gap between a fixed and a movable component comprising;
a sensor for providing an output signal which varies with an amount of deflection of said sensor;
a control means, comprising:
means for storing a threshold value;
means for comparing said sensor output signal with said threshold value; and
output means to provide a control signal on the basis of said comparison;
wherein said sensing means further comprises a threshold setting means arranged to sample the sensor output signal at a predetermined state of the gap and where said threshold setting means is further operable to store a threshold value based on the sampled value.

2. A sensing means according to claim 1, wherein said threshold setting means is arranged store said threshold value when said sensing means is initially activated.

3. A sensing means according to claim 1 or claim 2, wherein the sensor comprises a radiation emitter, a radiation guide, and a radiation detector, the arrangement being such that radiation emitted from the radiation emitter passes along the radiation guide to be detected by the radiation detector, and wherein deflection of the sensor decreases the transmissivity of the radiation guide.

4. A sensing means according to claim 3, wherein the radiation emitter is a light source, and the radiation detector is a photoelectric detector.

5. A sensing means according to claim 4, wherein the light source is a source of visible light.

6. A sensing means according to claim 4, source is a source of infra-red or ultraviolet light.

7. A sensing means according to claim 3, wherein the radiation emitter is a loudspeaker, and the radiation detector is a microphone.

8. A sensing means according to claim 7, wherein the radiation emitter is arranged to emit ultrasound.

9. A sensing means according to any preceding claim, wherein said threshold sensing means is arranged to store a plurality of threshold values, and said control means includes selection means for selecting a threshold value from said plurality of stored threshold values.

10. A sensing means according to claim 9, wherein said threshold sensing means includes threshold calculation means for calculating said plurality of threshold values on the basis of the sampled value.

11. A sensing means according to claim 9 or claim 10, further comprising a position detecting means for detecting the position of the moveable component and wherein said threshold setting means is arranged to store a plurality of said selection values and said control means is operable to select a threshold value according to the position of the moveable component.

12. A sensing means according to any of claims 9 to 11, further comprising means for detecting a parameter related to ambient conditions, and wherein said selection means is operable to select a threshold value on the basis of the detected ambient parameter.

13. A sensing means according to claim 12, wherein the detected ambient parameter is temperature.

14. A sensing means substantially as herein described with reference to FIG. 1, FIGS. 2a and 2b, or FIG. 9 of the accompanying drawings.

15. A method of detecting the presence of a body in a gap between a fixed and a movable component, comprising:
providing a sensor along an edge of the gap, the sensor having an output signal which varies with an amount of deflection of the sensor;
storing a threshold value in a memory means;
comparing the output signal from the sensor with said threshold value in a comparator means;
providing a control signal from a control means on the basis of the result of said comparison; characterised by sampling the sensor output signal at a predetermined state of the gap, and setting the threshold value on the basis of the sampled sensor output signal.

16. A method according to claim 15, further comprising the steps of:
storing a plurality of threshold values in the memory means; and
selecting, in a selecting means, one of said plurality of threshold values.

17. A method according to claim 16, wherein the selection is made by selecting means on the basis of the distance between the fixed and the movable component.

18. A method according to claim 16 or claim 17, further comprising the step of:
detecting an environmental parameter;
and wherein the selection of one of said plurality of threshold vales is made by the selecting means on the basis of the detected environmental parameter.

19. A method for detecting the presence of a body in a gap, substantially as described herein with reference to FIGS. 4, 5, 7 or 8 of the accompanying drawings.
